(19) United States
(12) Patent Application Publication
(10) Pub. No.: US 2009/0282262 A1
(43) Pub. Date: Nov. 12, 2009

(54) Information Processing Apparatus, Information Processing System, and Encryption Information Management Method

(75) Inventors: Akihiro Nonoyama, Komae-shi (JP); Koichiro Kamura, Fujisawa-shi (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/337,412

(22) Filed: Dec. 17, 2008

(30) Foreign Application Priority Data
May 9, 2008 (JP) 2008-123908

(51) Int. Cl. G06F 12/14

(52) U.S. Cl. 713/189

(57) ABSTRACT

According to one embodiment, the user virtual machine includes, a cryptographic key generating module configured to generate a cryptographic key for encrypting data an encryption module configured to encrypt data using the cryptographic key, an information generation module configured to generate information required for decrypting the encrypted data, a monitoring module configured to monitor generation of the cryptographic key, an instructing module configured to instruct the information generation module to generate the information when the monitoring module detects generation of the cryptographic key, and a transmitting module configured to transmit information generated according to instruction from the instructing module to the management virtual machine, and the management virtual machine includes a receiving module configured to receive information transmitted from the transmitting module, and a storing module configured to store the received information the storage apparatus allocated to the management virtual machine.

### CROSS-REFERENCE TO RELATED APPLICATIONS

This application is based upon and claims the benefit of priority from Japanese Patent Application No. 2008-123908, filed May 9, 2008, the entire contents of which are incorporated herein by reference.

### BACKGROUND

1. Field

The present invention relates to an information processing apparatus, an information processing system, and an encryption information management system where a cryptographic key is generated and information required to restore data encrypted using the cryptographic key is managed.

2. Description of the Related Art

As an operating system provided after Windows® 2000, there is a system which supports a function of allowing encryption for each folder or each file, called EFS.

In the EFS, encryption of a file can be performed even by a user who does not have administrative authority, and a cryptographic key and a certificate in a public cryptographic key system are generated automatically at an encryption time of a file. Encryption of a file itself is performed by a common cryptographic key system and the common cryptographic key is encrypted using a public cryptographic key.

In preparation for a case that a user has lost a key required to perform decryption, it is possible to generate information required to recover encrypted data (hereinafter, called “recovery certificate”) to recover the data using the generated information. It is necessary to use a function of archiving the recovery certificate in such a medium as another USB drive or the like together.

The recovery certificate must be handled carefully, because, when it is passed on to someone else, he/she can restore the encrypted data.

Jpn. Pat. Appln. KOKAI Publication No. 2007-233704 discloses a technique for protecting confidentiality by causing only one of virtual machines of two systems to process a confidential document in an information processing apparatus utilizing virtual machines.

The recovery certificates are collectively administrated under Windows domain environment by a domain controller. However, a user must implement instruction/management of generation of a recovery certificate under stand-alone environment utilized in a work group or the like.

It is difficult for a person or a user unfamiliar with operation of Windows to conduct the abovementioned management. Even if a user is able to generate a recovery certificate, he/she may forget a storage place of the recovery certificate or a key required for deciphering is broken. In such a case, the recovery certificate is lost, which results in impossibility of recovery of a file.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary diagram showing a configuration of an information processing apparatus according to a first embodiment;

FIG. 2 is an exemplary block diagram showing an EFS encryption module for carrying out encryption of a file or a folder in EFS;

FIG. 3 is an exemplary diagram for explaining a procedure of encryption performed by EFS;

FIG. 4 is an exemplary block diagram showing a configuration for managing a certificate according to the first embodiment;

FIG. 5 is an exemplary diagram showing a configuration of an information processing system according to a second embodiment;

FIG. 6 is an exemplary diagram showing a configuration of a cryptographic key management virtual machine;

FIG. 7 is an exemplary block diagram showing a configuration of a distributed processing module according to the second embodiment;

FIG. 8 is an exemplary diagram showing an example where data is divided to eight blocks and respective divided data blocks are distributed to eight computers fourfold and are saved; and

FIG. 9 is an exemplary diagram showing an example where an original certificate is restored from divided data blocks.

### DETAILED DESCRIPTION

Various embodiments according to the invention will be described hereinafter with reference to the accompanying drawings. In general, according to one embodiment of the invention, an information processing apparatus where a user virtual machine and a management virtual machine are allocated to a plurality of logically divided computational resources including storage apparatus and operating systems run in the user virtual machine and the management virtual machine concurrently, respectively, wherein the user virtual machine comprises a cryptographic key generating module configured to generate a cryptographic key for encrypting data, an encryption module configured to encrypt data using the cryptographic key, an information generation module configured to generate information required for decrypting the encrypted data, a monitoring module configured to monitor generation of the cryptographic key, an instructing module configured to instruct the information generation module to generate the information when the monitoring module detects generation of the cryptographic key, and provided in the user virtual machine, and a transmitting module configured to transmit information generated according to instruction from the instructing module to the management virtual machine, and the management virtual machine comprises a receiving module configured to receive information transmitted from the transmitting module, and a storing module configured to store the received information the storage apparatus allocated to the management virtual machine, and provided in the management virtual machine.

### First Embodiment

First, a configuration of an information processing apparatus according to a first embodiment of the present invention will be explained with reference to FIG. 1. The information processing apparatus is realized as a personal computer 10. Environment where a virtual technique (Virtual Monitor) provided, for example, by XEN, VMWARE, or the like is performed is prepared for the computer 10.

The computer 10 includes a hardware layer (computational resource) 11, a virtual machine monitor 12, a user virtual machine 20, cryptographic key management virtual machine 30, and the like.

The hardware layer 11 includes a display, a hard disk drive (HDD), a network interface card, a keyboard, a mouse, and the like.

The virtual machine monitor 12 manages the hardware layer 11 and conducts allocation of resources to the respective virtual machines 20 and 30. The virtual machine monitor 12 divides the hardware layer (computational resource) 11 into a plurality of blocks logically to allocate the respective virtual machines to the pieces and sort execution schedules of the respective virtual machines and I/O demands from the virtual machines to the respective pieces of the hardware layer 11.

The user virtual machine 20 includes a user operating system (user OS) 21, a user application (user APP) 22, and the like. The user operating system 21 is an operating system for providing an environment generally used by a user. In general, an operating system of Windows system is used as the user operating system 21. The user application 22 is an application software running on the user operating system 21.

The management virtual machine 30 includes a service operating system 31, a management application (management APP) 32, a certificate management storage 33, and the like. The service operating system 31 is an operating system for operating the management application 32. For example, Linux® is used as the service operating system 31. The certificate management storage 33 is a resource allocated to the cryptographic key management virtual machine 30 of a storage apparatus (for example, hard disk drive) configuring the hardware layer 11, logically divided.

Incidentally, the user virtual machine 20 cannot see data in the management virtual machine 30 and cannot access the data directly.

Now, the user operating system 21 is an encryption file system called EFS (encryption file system), and provides a function of allowing encryption for each folder or each file.

In the EFS, encryption of a file can be performed even by a user who does not have administrative authority, where a cryptographic key and a certificate in a public cryptographic key system are automatically generated at an encryption time of a file. Encryption of a file itself is encrypted in a common cryptographic key system and the common cryptographic key is encrypted using a public cryptographic key.

In preparation for such a case that the user has lost the key, such a configuration is adopted that data restoring can be performed by restoring agent. The restoring agent can be managed in a domain as policy.

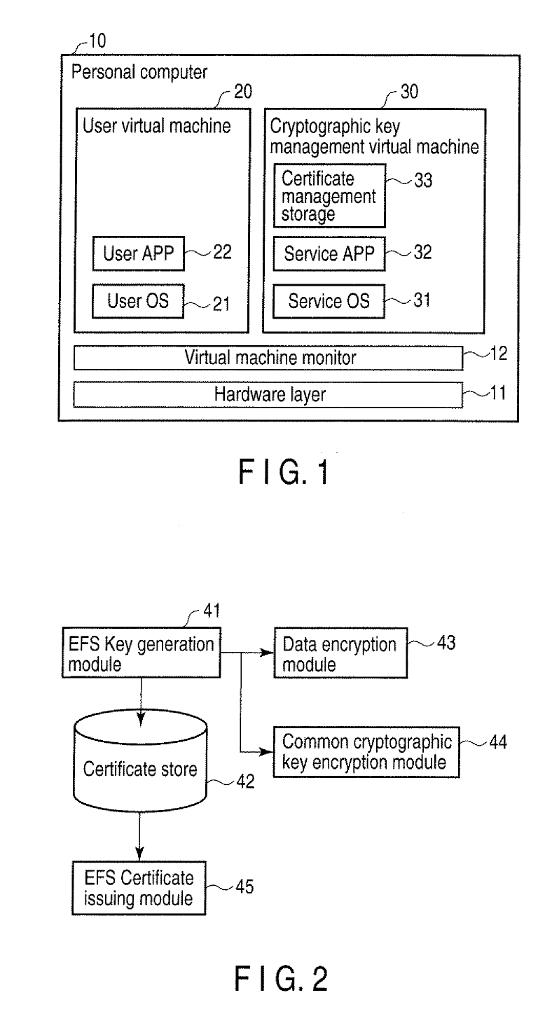

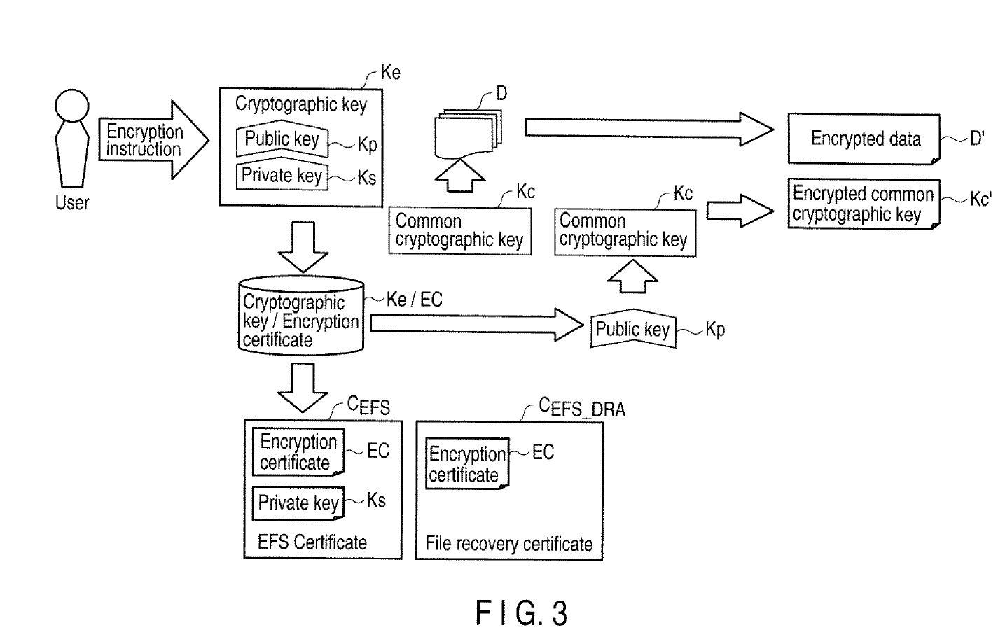

A procedure of encryption performed by the EFS will be explained with reference to FIGS. 2 and 3.

FIG. 2 is a block diagram showing an EFS encryption module which performs encryption of a file or a folder in the EFS.

As shown in FIG. 2, the EFS encryption module includes an EFS key generation module 41, a certificate store 42, a data encryption module 43, a common cryptographic key encryption module 44, a certificate issuing module 45, and the like.

The EFS key generation module 41 generates a cryptographic key of a public encryption system. The EFS key generation module 41 generates an encryption certificate to register the same in the certificate store 42. The data encryption module 43 encrypts a file or data in a folder designated by a user using a common key. The common cryptographic key encryption module 44 encrypts the common key using a public key. The encrypted common key is stored in a predetermined location. The EPS certificate issuing module 45 generates an encryption file system certificate (hereinafter, called “EFS certificate”) or a file recovery certificate (hereinafter, called “FS DRA certificate”). A private key and an encryption certificate are stored in the EFS certificate. The encryption certificate is stored in the file recovery certificate.

FIG. 3 is a diagram for explaining a procedure of encryption performed by the EFS.

A user sets encryption to data D such as a file or a folder. Thereby, the EFS key generation module 41 generates a cryptographic key Ke of a public encryption system. The cryptographic key Ke comprises a public key Kp and a private key Ks. The EFS key generation module 41 issues an encryption certificate EC according to generation of the cryptographic key Ke.

When generation, change, or movement of a file has been performed regarding a target folder, the data encryption module 43 encrypts a file or data in a folder designated by the user using a common key Kc.

The common cryptographic key encryption module 44 encrypts the common key Kc using the public key Kp. The cryptographic key Ke and the certificate EC are managed in a file system of Windows.

The certificate issuing module generates an EFS certificate C_{EFS} or a file recovery certificate C_{EFS}_{_{—}}_{DRA} according to user's designation.

Now, When the EFS certificate C_{EFS} or the file recovery certificate C_{EFS}_{_{—}}_{DRA} (hereinafter, called “certificate C” collectively) is acquired by anyone else, decryption can be performed easily, so that the certificate must be stored in a safe place. In the computer 10, the certificate C generated in the user virtual machine 20 is managed in the cryptographic key management virtual machine 30, so that the certificate C is prevented from being stolen by anyone else.

A configuration and a procedure of a processing for managing a certificate C generated by the user virtual machine 20 at the cryptographic key management virtual machine 30 will be explained below.

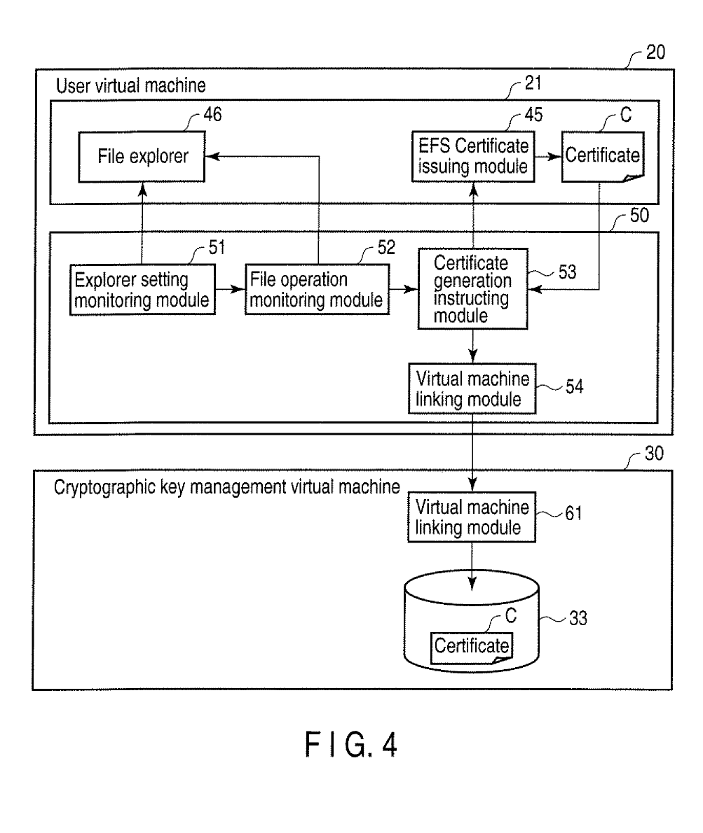

FIG. 4 is a block diagram showing a configuration for managing a certificate according to the first embodiment of the present invention.

As shown in FIG. 4, the user virtual machine 20 includes thy EPS certificate issuing module 45, a file explorer 46, a system monitoring module 50, and the like. The data encryption module 43, the EFS certificate issuing module 45, and the file explorer 46 are software modules provided by the user operating system 21.

The cryptographic key management virtual machine 30 includes a virtual machine linking module 61 and a certificate management storage 33.

A management processing of a certificate performed by the user virtual machine 20 and the cryptographic key management virtual machine 30 will be explained below.

The system monitoring module 50 is a program running on the user operating system 21, and it remains in the system to monitor operation of the operating system 21. The system monitoring module 50 comprises an explorer setting monitoring module 51, a file operation monitoring module 52, a certificate generation instructing module 53, a virtual machine linking module 54, and the like.

When a user implements encryption of a file or folder, he/she performs setting of the encryption using a file management program (for example, a file explorer) 46. The explorer setting monitoring module 51 monitors operation of the file explorer 46 to monitor whether or not encryption setting has been performed. The explorer setting monitoring module 51 calls the file operation monitoring module 52 when it detects setting of the encryption.

When setting of encryption has been implemented, generation of a cryptographic key corresponds to a case that a folder is generated in a folder to be encrypted or a case that a file has been first generated and moved. The file operation monitoring module 52 monitors operation of the file explorer 46 and it calls the certificate generation instructing module 53 when a corresponding operation has occurred.

The certificate generation instructing module 53 instructs the EFS certificate issuing module 45 to issue a certificate C. The certificate generation instructing module 53 acquires the issued certificate C. The certificate generation instructing module 53 calls the virtual machine linking module 54 to deliver the acquired certificate C to the virtual machine linking module 54.

The virtual machine linking module 54 on the side of the user virtual machine 20 transmits (moves) the certificate C to the virtual machine linking module 61 on the side of the cryptographic key management virtual machine 30. After the transmission, the virtual machine linking module 54 deletes the certificate C remaining in the user virtual machine 20. The virtual machine linking module 61 stores the certificate C in the certificate management storage 33.

According to the abovementioned processing, the certificate C is deleted from the user virtual machine 20 and the certificate C is managed by the cryptographic key management virtual machine 30. Incidentally, when a failure occurs in the user virtual machine 20 and the certificate C is required, input of information from a user virtual machine 20 newly installed or another computer connected to the computer 10 is performed so that the certificate C in the certificate management storage 33 is looked up. Incidentally, looking up the certificate is performed through the virtual machine linking module 61.

### Second Embodiment

In the abovementioned example, when trouble occurs in both of the user virtual machine 20 and the cryptographic key management virtual machine 30, encrypted data cannot be recovered. In this embodiment, an example where a certificate C is made redundant will be explained.

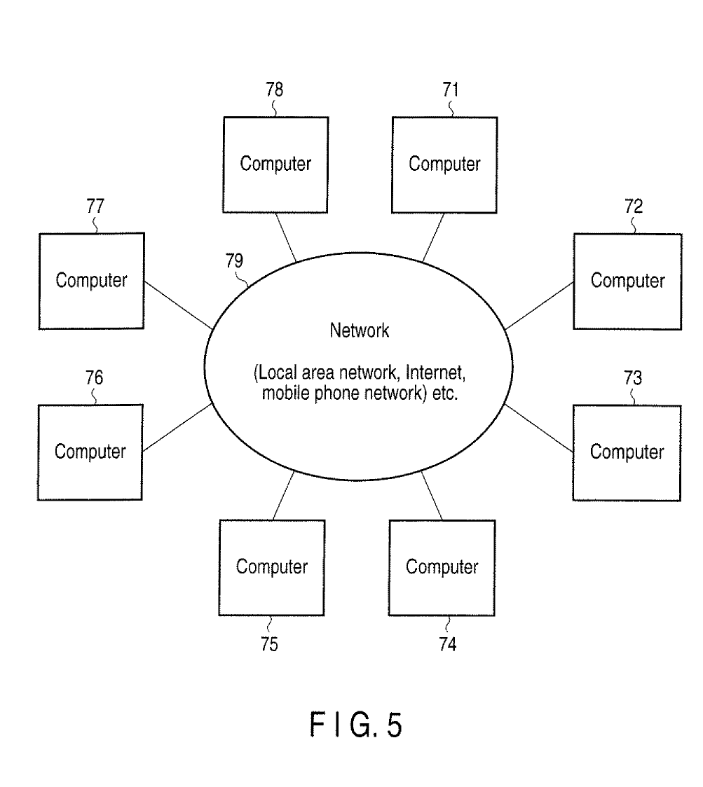

FIG. 5 is a diagram showing a configuration of an information processing system according to the second embodiment of the present invention.

As shown in FIG. 5, a plurality of computers 71 to 78, each serving as an information processing apparatus, are connected to a network 79. The plurality of computers 71 to 78 can perform mutual communication via the network 79 such as in-house LAN (wired LAN or wireless LAN), Internet, or a mobile communication network.

Incidentally, in each of the computers 71 to 78, a user virtual machine 20 and a cryptographic key management virtual machine 30 run on a virtual machine monitor in the same manner as the computer explained in the first embodiment. A configuration of the user virtual machine of each of the computers 71 to 78 is similar to that of the user virtual machine 20 shown in FIG. 4. A configuration of the cryptographic key management virtual machine 30 of each of the computers 71 to 78 is similar to that of the cryptographic key management virtual machine 30 shown in FIG. 4, but the former is partially different from the latter.

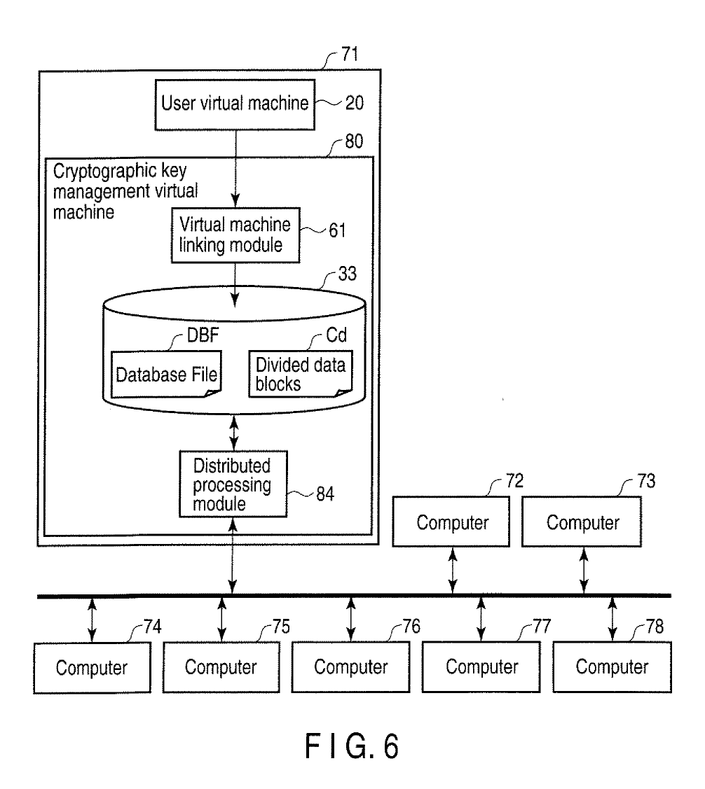

Therefore, a configuration of the cryptographic key management virtual machine of the computer 71 will be explained as an example with reference to FIG. 6. Incidentally, in FIG. 6, same portions as those shown in FIG. 4 are attached with same reference numerals and explanation thereof is omitted.

As shown in FIG. 6, the cryptographic key management virtual machine 80 includes a distributed processing module 84. The distributed processing module 84 performs a processing for storing divided data blocks Cd obtained by diving a certificate C transmitted by the user virtual machine 20 corresponding to respective management virtual machines 30 of N (N=8) computers 71 to 78 in the respective management virtual machines 30 in a distributed and multiplexed manner. A certificate management storage 33 is a resource allocated to a cryptographic key management virtual machine 80 of a storage apparatus (for example, hard disk drive) configuring a hardware layer 11, logically divided, in the same manner as the certificate management storage 33 shown in FIG. 4.

Information where information about a source computer to a divided data block stored in the certificate management storage 33 and information about what number data block of the original certificate C the divided data block Cd is associated with each other is stored in a database file DBF.

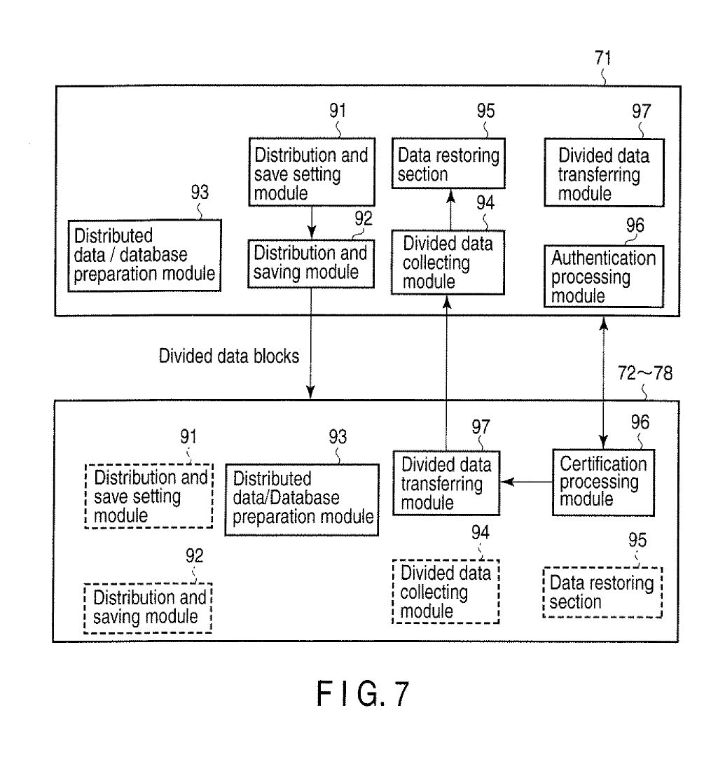

Next, a configuration of the distributed processing module 84 provided in each of the computers 71 to 78 will be explained with reference to FIG. 7.

Each distributed processing module 84 includes a distribution and save setting module 91, a distribution and saving module 92, a database preparation module 93, a divided data collecting module 94, a data restoring module 95, an authentication processing module 96, a divided data transferring module 97, and the like.

The distribution and save setting module 91 sets how to distribute and save the divided data blocks of a certificate C when the divided data blocks are saved in the certificate management storages 33 of the respective computers 71 to 78 in a distributed and multiplexed manner. Incidentally, such a configuration can be adopted that the distribution and save setting module 91 transmits setting information to each computer and each computer saves the setting information.

The distribution and saving module 92 divides the certificate C to N blocks based upon the setting determined by the distribution and save setting module 91. The distribution and saving module s 92 save N-divided data blocks of the certificate C in N computers in an M-fold distributed manner. Incidentally, source identifying information for identifying a source computer of the certificate C and division information about what number data block of the divided original certificate C the divide data block is transmitted at a transmission time of the divided data blocks Cd. For example, these information blocks are stored in a header of a packet when they are transmitted. Alternatively, before or after the transmission of the divided data block Cd, data including a file name of the divided data block Cd, source identifying information, and division information is transmitted. After the distribution and saving module 92 transmits the divided data blocks Cd, it deletes the original certificate C.

The database preparation module 93 performs generation/update of database data in which information where source identifying information and division information are caused to correspond to the divided data block Cd is stored at a saving time of the divided data block Cd. The database preparation module 93 prepares information where source identifying information and division information are associated with the divided data block Cd, for example, based upon the source identifying information and the division information transmitted at a time of transmission of data performed by the distribution and saving module 92. The database preparation module 93 prepares information where the source identifying information and the division information are associated with the divided data block Cd to data to be divided which is saved in its own certificate management storage 33 from setting information transmitted by the distribution and save setting module 91. The database preparation module 93 performs preparation/update of database data saved in the certificate management storage 33 based upon the information. Incidentally, the database preparation module 93 prepares information associating the source identifying information and the division information with each other to the divided data block which has been stored in the own certificate management storage 33 to perform preparation/update of the database.

The divided data collecting module 94 selectively collects N divided data blocks obtained by dividing the data to N blocks from at least (N−M+1) computers 71 to 78. At this time, when the divided data collecting module 94 collects divided data blocks which are not saved in the own certificate management storage 33₁ from the other computers, it transmits a divided data transfer request to the other computers 72 to 78. The divided data transferring module s 97 in the other computers 72 to 78 which have received the divided data transfer request transmit the requested divided data blocks from the divided data collecting module s 94 to the cryptographic key management virtual machine 30 of the computer 71 which has transmitted the divided data transfer request.

Incidentally, prior to transfer of the divided data block from each divided data transferring module 97, the authentication processing module 96 performs an authentication processing between the same and the computer which has transmitted the divided data transfer request. When the authentication processing is successful, the divided data transferring module 97 transfers the divided data block to the cryptographic key management virtual machine 80. Incidentally, it is possible to transfer the divided data block without performing the authentication processing. However, in view of security, it is preferable that the authentication processing is performed.

The data restoring module 95 combines N divided data blocks selectively collected by the divided data collecting module 94 to restore the original data.

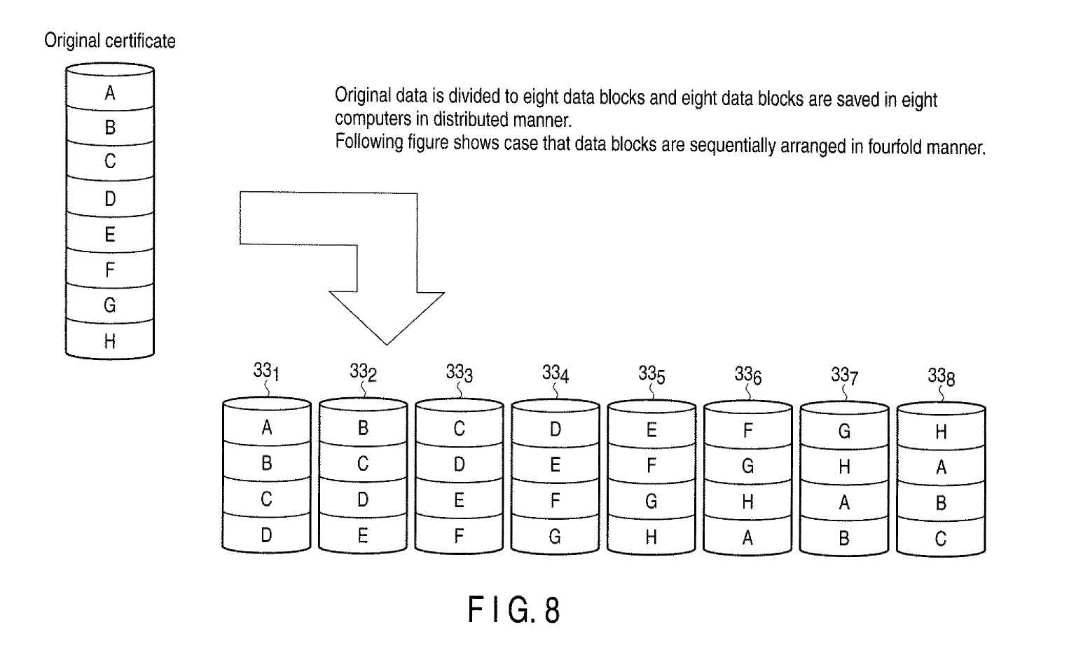

FIG. 8 shows an example where a certificate C is distributed and saved (N=8 and M=4). As shown in FIG. 8, after a computer x (x: one of 1 to 8) generates original data, the distributed processing module 84 divides an original certificate C into eight divided data blocks A to H. Thereafter, the distributed processing module 84 causes the other computers to save the divided data blocks A to H based upon setting performed by the distribution and save setting module 91 in a distributed fourfold manner.

In this example, distribution is performed such that the certificate management storage 33₁ in the computer 71 saves the data blocks A to D, the certificate management storage 33₂ in the computer 72 saves the data blocks B to E, the certificate management storage 33₃ in the computer 73 saves the data blocks C to F, and each of the certificates management storages 33₄ to 33₈ in the computers 74 to 73 also saves four divided data blocks different in combination of divided data blocks, respectively.

Next, a procedure of restoring the original data from the divided data blocks saved in the abovementioned procedure will be explained. For example, the divided data collecting module 94 looks up database data blocks stored in the certificate management storages 33 in the respective computers 71 to 78 to detect the computers 71 to 78 in which divided data blocks are stored in order to require restoring of the certificate C and the divided data blocks to be acquired from the computers 71 to 78. The divided data collecting module 94 acquires divided data blocks from the respective computers 71 to 78 based upon the computers and divided data blocks detected. The data restoring module 95 restores the original certificate C using the distributed data blocks collected by the divided data collecting module 94.

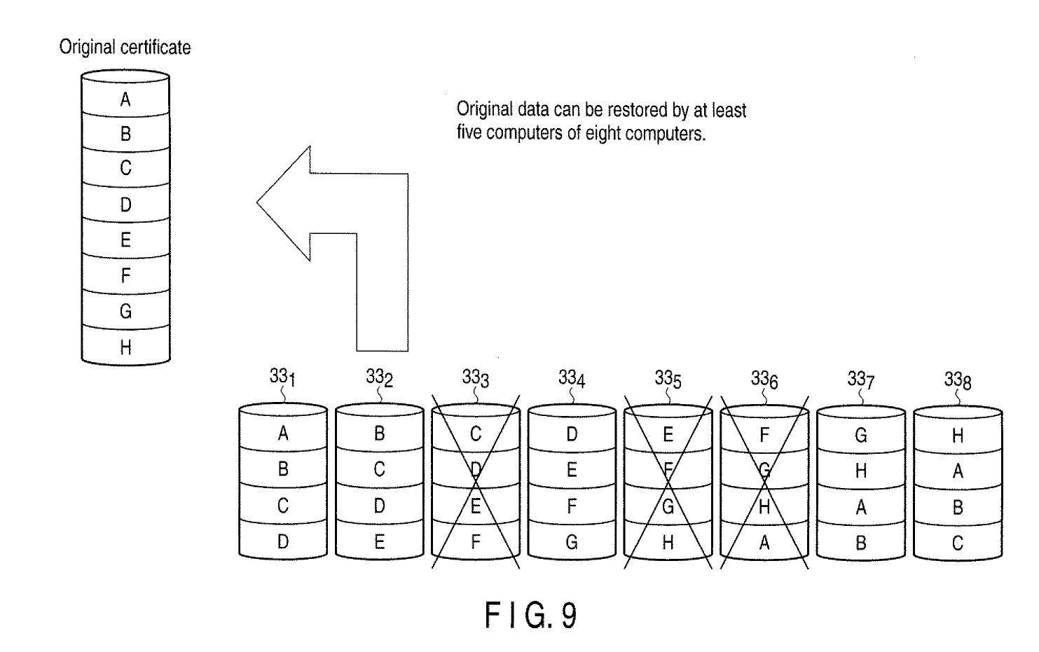

FIG. 9 shows a case where a computer x restores the original certificate C from four divided data blocks saved in each of 8 computers 71 to 78 in a distributed manner. In this example, an example where three computers (computer 73, computer 75, and computer 76) are not connected to the network due to damages or the like is shown.

As understood from FIG. 9, the computer x cannot look up or receive the divided data blocks (C, D, E and F) saved by the computer 73, the divided data blocks (E, F, G and H) saved by the computer 75, and the divided data blocks (F, G, H and A) saved by the computer 76 from the computer 73, the computer 75 and the computer 76 via network.

However, the following will be understood from FIG. 9.

The divided data block C can be looked up or received from one of the computer 71, the computer 72, and the computer 78.

The divided data block D can be looked up or received from one of the computer 71, the computer 72 and the computer 74.

The divided data block E can be looked up or received from one of the computer 72 and the computer 74.

The divided data block F can be looked up or received from the computer 74.

The divided data block G can be looked up or received from one of the computer 74 and the computer 77.

The divided data block H can be looked up or received from the computer 77 and the computer 78.

The divided data block A can be looked up or received from one of the computer 71, the computer 77, and the computer 78.

The divided data block B can be looked up or received from one of the computer 71, the computer 72, and the computer 77.

Accordingly, the computer x can collect 8 divided data blocks A to H in total from the other four computers connected to the network.

Thus, when the original information is divided into N blocks and N division information blocks are saved in N computers M blocks by M blocks, the original certificate C can be restored by utilizing at least (N−M+1) computers.

In the distributed storages, since a certificate C stored by secret distribution is stored in a computer system configuring distribution storages as partial information blocks configuring a cryptographic key, redundancy and confidence of information can be improved.

In the embodiment described above, the example where the user operating system is Windows has been explained, but the user operating system may be another operating system.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

1. An information processing apparatus where a user virtual machine and a management virtual machine are allocated to a plurality of logically divided computational resources including a storage apparatus and operating systems run concurrently in the user virtual machine and the management virtual machine, respectively, wherein the user virtual machine comprises:
a cryptographic key generating module configured to generate a cryptographic key for encrypting data;
an encryption module configured to encrypt data using the cryptographic key;
an information generation module configured to generate information required for decrypting the encrypted data;
a monitoring module configured to monitor generation of the cryptographic key;
an instructing module configured to instruct the information generation module to generate the information when the monitoring module detects generation of the cryptographic key; and
a transmitting module configured to transmit information generated according to an instruction from the instructing module to the management virtual machine, and
the management virtual machine comprises:
a receiving module configured to receive information transmitted from the transmitting module; and
a storing module configured to store the received information in the storage apparatus allocated to the management virtual machine.

2. The information processing apparatus of claim 1, wherein after the transmitting module transmits the information to the management virtual machine, the information in the user virtual machine is deleted.

3. The information processing apparatus of claim 1, wherein
the cryptographic key comprises a public key for encrypting data in a public key encryption system, and
the user virtual machine further comprises a data encryption module configured to encrypt data designated by a user using a common key and a common key encryption module configured to encrypt the common key using the public key.

4. An information processing system where information processing apparatuses where a user virtual machine and a management virtual machine are allocated to computational a plurality of logically divided resources including a storage apparatus and operating systems run concurrently in the user virtual machine and the management virtual machine, respectively, are connected to a network, wherein the user virtual machine in each of the information processing apparatuses comprises:
a generating cryptographic key module configured to generate a cryptographic key for encrypting data
an encryption module configured to encrypt data using the cryptographic key;
an information generation module configured to generate information required for decrypting the encrypted data;
a monitoring module configured to monitor generation of the cryptographic key;
an instructing module configured to instruct the information generation module to generate the information when the monitoring module detects generation of the cryptographic key; and
a transmitting module configured to transmit information generated according to an instruction from the instructing module to the management virtual machine, and
the management virtual machine in each of the information processing apparatuses comprises:
a receiving module configured to receive information transmitted from the transmitting module;
a module configured to divide the received information into a plurality of blocks, and to transmit the divided information to the management virtual machines in other information processing apparatuses connected to the network in a distributed manner; and
a storing module configured to store the information transmitted from the other management virtual machine in storage apparatuses allocated to their own management virtual machines.

5. The information processing system of claim 4, wherein after the transmitting module transmits the information to the management virtual machine, the information in the user virtual machine is deleted.

6. The information processing system of claim 4, wherein after the received information is divided into a plurality of blocks, the information before divided is deleted from the management virtual machine.

7. The information processing system of claim 4, wherein
the cryptographic key comprises a public key for encrypting data in a public key encryption system, and
the user virtual machine further comprises data encryption module configured to encrypt data designated by a user using a common key and common key encryption module configured to encrypt the common key using the public key.

8. An encryption information management method of an information processing apparatus where a user virtual machine and a management virtual machine are allocated to a plurality of computational resource including a logically divided storage apparatuses and operating systems run concurrently in the user virtual machine and the management virtual machine, respectively, comprising:
generating a cryptographic key for encryption by the user virtual machine;
encrypting data using the cryptographic key by the user virtual machine;
monitoring generation of the cryptographic key by the user virtual machine;
instructing generation of information required to decrypt the encrypted data by the user virtual machine when generation of the cryptographic key is detected;
generating information required to decrypt the encrypted data according to the instruction by the user virtual machine;
transmitting information generated according to the instruction to the management virtual machine by the user virtual machine;
receiving information transmitted from the transmitting module by the management virtual machine; and
storing at least a portion of the received information in a storage apparatus allocated to the management virtual machine by the management virtual machine.

9. The encryption information management method of claim 8, wherein after the information is transmitted to the management virtual machine, the information in the user virtual machine is deleted.

10. The encryption information management method of claim 8, wherein the received information is divided into a plurality of blocks by the management virtual machine and the divided information is transmitted to the management virtual machines in other information processing apparatuses connected to the network in a distributed manner.

11. The encryption information management method of claim 9, wherein information transmitted from the other management virtual machine is stored in a storage apparatus in an own management virtual machine.

12. The encryption information management method of claim 9, wherein after the received information is divided into a plurality of blocks, the received information before divided is deleted from the management virtual machine.

13. The encryption information management method of claim 8, wherein
the cryptographic key comprises a public key for encrypting data in a public key encryption system, and
the user virtual machine further comprises a data encryption module configured to encrypt data designated by a user using a common key and a common key encryption module configured to encrypt the common key using the public key.
